(19) United States
(12) Patent Application Publication
(10) Pub. No.: US 2015/0268807 A1
(43) Pub. Date: Sep. 24, 2015

(54) ADJUSTING A SIZE OF AN ACTIVE REGION WITHIN A GRAPHICAL USER INTERFACE

(71) Applicant: GOOGLE INC., MOUNTAIN VIEW, CA (US)

(72) Inventors: Steven Chi TRUONG, Toronto (CA); Jorge Taketoshi FURUYA, Cupertino, CA (US); Alexander Friedrich KUSCHER, San Francisco, CA (US)

(73) Assignee: GOOGLE INC., MOUNTAIN VIEW, CA (US)

(21) Appl. No.: 14/220,079

(22) Filed: Mar. 19, 2014

(51) Int. Cl. G06F 3/0484

(52) U.S. Cl. CPC G06F 3/0484

(57) ABSTRACT

A system and machine-implemented method of adjusting a size of an active region within a graphical user interface are provided. A stored association is accessed between a first input element of a graphical user interface and prior touch input corresponding to the first input element. Based on the accessed association, a size of an active region for at least one of the first input element or a second input element of the graphical user interface may be increased or decreased. The graphical user interface based on the increased or decreased size of the active region is displayed.

### BACKGROUND

The present disclosure generally relates to graphical user interfaces, and in particular, to adjusting a size of an active region within a graphical user interface.

Computing devices with touch-sensitive screens (e.g., a touch screen) have improved the way users interact with computing devices, making the computing devices more intuitive and easier to use. Computing devices with touch-sensitive screens have given rise to graphical user interfaces that accept touch-based interactions.

### SUMMARY

The disclosed subject matter relates to a system for adjusting a size of an active region within a graphical user interface. The system comprises one or more processors, and a machine-readable medium comprising instructions stored therein, which when executed by the processors, cause the processors to perform operations comprising accessing a stored association between a first input element of a graphical user interface and prior touch input corresponding to the first input element. The operations further comprise adjusting, based on the accessed association, a size of an active region for at least one of the first input element or a second input element of the graphical user interface. In addition, the operations comprise displaying the graphical user interface based on the adjusted size of the active region.

The disclosed subject matter further relates to a machine-readable medium comprising instructions stored therein, which when executed by a system, cause the system to perform operations comprising accessing a stored association between a first input element of a graphical user interface and prior touch input corresponding to the first input element. The operations further comprise adjusting, based on the accessed association, a size of an active region for at least one of the first input element or a second input element of the graphical user interface. The operations further comprise receiving subsequent touch input within the graphical user interface. In addition, the operations comprise processing the received touch input based on the adjusted size of the active region.

The disclosed subject matter also relates to a computer-implemented method of adjusting a size of an active region within a graphical user interface. The method comprises accessing a stored association between a first input element of a graphical user interface and prior touch input corresponding to the first input element. The method further comprises increasing or decreasing, based on the accessed association, a size of an active region for at least one of the first input element or a second input element of the graphical user interface. In addition, the method comprises displaying the graphical user interface based on the increased or decreased size of the active region.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example network environment which provides for adjusting an active region within a graphical user interface.

FIG. 2 illustrates a flow diagram of an example process for adjusting an active region within a graphical user interface.

FIGS. 3A-3C illustrate example graphical user interfaces running on a computing device, where the graphical user interfaces include one or more active regions for one or more selectable graphical elements.

FIG. 4 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, computing devices with touch-sensitive screens (e.g., a touch screen) have improved the way users interact with computing devices, making the computing devices more intuitive and easier to use. Computing devices with touch-sensitive screens have given rise to graphical user interfaces that accept touch-based interactions.

Interacting with a touch-sensitive screen (e.g., a touch screen) may be problematic. In example aspects, when a user is typing on a touch screen, incorrect keys may be pressed due to lack of haptic-feedback. Alternatively or in addition, high tendency of errors may be introduced due to the compact size of the virtual keyboard on the touch screen. The user can be frustrated when the key pressed erroneously is a system key which has a different function than the character key the user intended to press. For example, if the user pressed on a globe key on an internationalized keyboard by accident, the keyboard language may be changed. The user may have to press the globe key again to switch back to the correct keyboard language. Alternatively or in addition, inappropriate system changes may be introduced when various system function keys (e.g., mute key and volume key) are accidentally pressed on a touch screen keyboard.

The subject disclosure provides for adjusting a size of an active region within a graphical user interface. A stored association is accessed between a first input element (e.g., a selectable graphical element) of a graphical user interface and prior touch input corresponding to the first input element. Based on the accessed association, a size of an active region for at least one of the first input element or a second input element of the graphical user interface is adjusted. The graphical user interface based on the adjusted size of the active region is displayed.

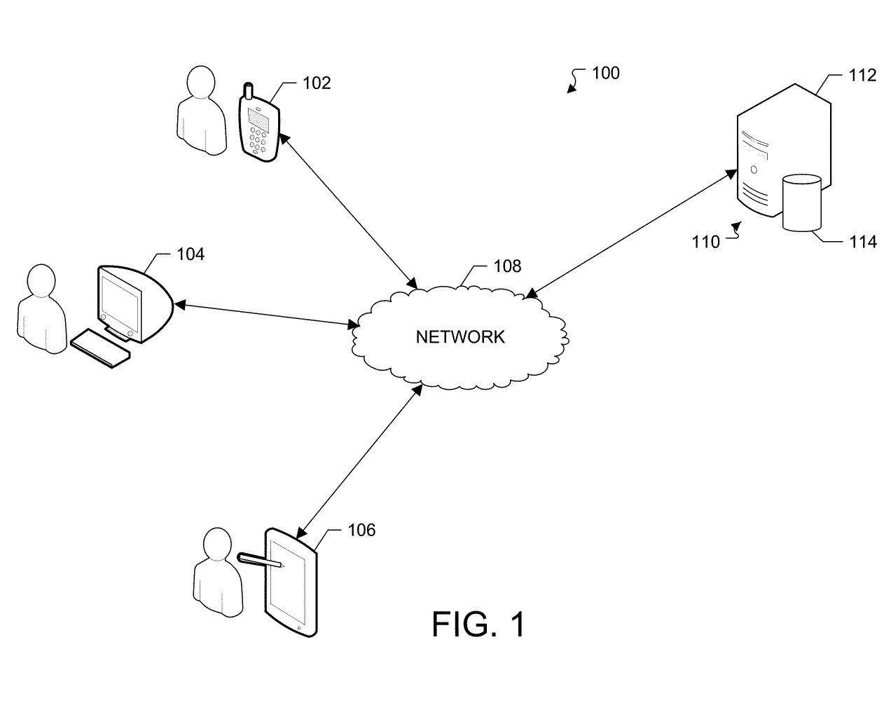

FIG. 1 illustrates an example network environment which provides for adjusting an active region within a graphical user interface. A network environment 100 includes computing devices 102, 104 and 106 (hereinafter “102-106”) and computing system 110 (hereinafter “110-112”). Computing devices 102-106 and computing system 110 can communicate with each other through a network 108. Computing system 110 can include one or more computing devices 112 (e.g., one or more servers), and one or more computer-readable storage devices 114 (e.g., one or more databases).

Each of computing devices 102-106 can represent various forms of processing devices. Example processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Computing devices 102-106 and 112 may be provided access to or receive application software executed or stored on any of the other computing systems 102-106 and 112.

Computing device 112 may be any system or device having a processor, a memory, and communications capability for providing content to the electronic devices. In some example aspects, server 110 can be a single computing device, for example, a computer server. In other embodiments, server 110 can represent more than one computing device working together to perform the actions of a server computer (e.g., cloud computing). Further, computing device 112 can represent various forms of servers including, but not limited to a web server, an application server, a proxy server, a network server, or a server farm.

In some aspects, the computing devices may communicate wirelessly through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, WiFi, or other such transceiver.

In some aspects, network environment 100 can be a distributed client/server system that spans one or more networks, for example, network 108. Network 108 can be a large computer network, for example, a local area network (LAN), wide area network (WAN), the Internet, a cellular network, or a combination thereof connecting any number of mobile clients, fixed clients, and servers. Further, the network 108 can include, but is not limited to, any one or more of the following network topologies, including a bus network, a star network, a ring network, a mesh network, a star-bus network, tree or hierarchical network, and the like. In some aspects, communication between each client (e.g., computing devices 102-106) and server (e.g., server 110) can occur via a virtual private network (VPN), Secure Shell (SSH) tunnel, or other secure network connection. In some aspects, network 108 may further include a corporate network (e.g., intranet) and one or more wireless access points.

In example aspects, a user at any of the client devices (e.g., any of computing devices 102-106), can provide user input within a graphical user interface on the computing device. More particularly, a client device (e.g., any of computing devices 102-106) may receive touch input from a user, the touch input corresponding to a first input element of a graphical user interface. The client device may store an association between the first input element and the received touch input.

In some aspects, the client device locally stores the association between the first input element of the graphical user interface and the received prior touch input. Alternatively, or in addition, the association may be stored remotely (e.g., on server 110).

The stored association, between the first input element of the graphical user interface and the prior touch input corresponding to the first input element, is accessed by the client device. Based on the accessed association, the client device adjusts a size of an active region for at least one of the first input element or a second input element of the graphical user interface. The client device provides for display the graphical user interface based on the adjusted size of the active region.

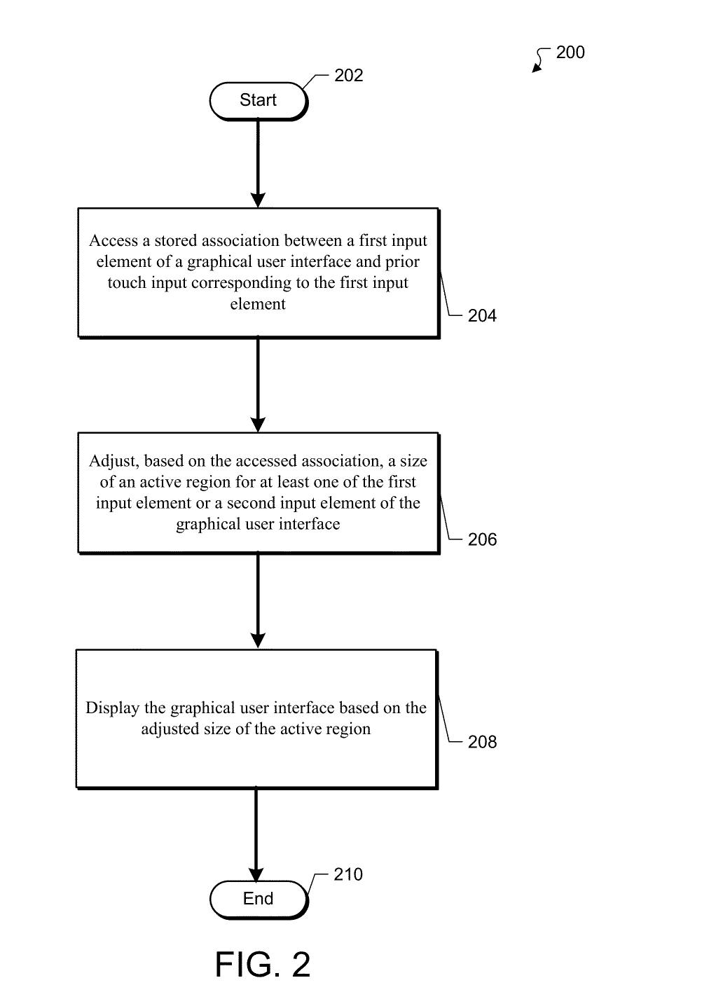

FIG. 2 illustrates a flow diagram of an example process for adjusting an active region within a graphical user interface. Following start block 202, a stored association between a first input element of a graphical user interface and prior touch input corresponding to the first input element is accessed at step 204.

A first input element of a graphical user interface may correspond to a selectable graphical element that can be selected by a touch input on a touch-sensitive screen (e.g., a touch screen). In a graphical user interface for handling touch input, one or more selectable graphical elements may be provided. For example, a web page may include one or more selectable graphical elements including, but not limited to, a button, check box, radio button, slider, list box, drop-down list, menu, combo box, icon, text box, scroll bar.

Prior to accessing the stored association, the prior touch input corresponding to the first input element may be received, and an association between the first input element of the graphical user interface and the received prior touch input may be stored.

In some aspects, the stored association may include that the prior touch input corresponds to a positive signal for the first input element. A positive signal may be, for example, a repeated or similar behavior from a user in a graphical user interface. For instance, a positive signal may be a user hitting the OK button frequently in a graphical user interface, rather than the CANCEL button. The prior touch input to select the OK button may correspond to a positive signal for the OK button in the graphical user interface.

Alternatively or in addition, the stored association may include that the prior touch input corresponds to a negative signal for the first input element. A negative signal may be a correction behavior from a user in a graphical user interface. For example, in a web browser user interface, the CLOSE button on web page A may be positioned close to a NEW tab button. A user may select a NEW tab button, followed by closing the newly-created tab, and then followed by selecting the CLOSE button on web page A. Closing the newly-created tab followed by selecting the CLOSE button may correspond to a negative signal for the NEW tab button.

In some aspects, the stored association may include that the prior touch input corresponds to touch input by a user in association with the first input element.

The association between the user and the first input element may be determined from one or more matching attributes between the user profile and the description of the first input element. The user profile may include, for example, a user name, user dates (e.g., birthday, anniversary, etc.), user location, user preferences, affinity and contact information, social activity associated with the user, and/or other similar information. The user location may include, for example, residential or work (e.g., the country where the user lives/works) location information. Alternatively, or in addition, the user location can correspond to a present location of the user, obtained, for example by location-based services (e.g., GPS, Wi-Fi, triangulation). The user profile may be remotely stored in association with a search engine service, or a social networking service (e.g., hosted on server 110). The graphical user interface on the user device (e.g., computing device 102-106) may obtain this information from the appropriate server.

The one or more matching attributes may include one or more keywords matches between the user profile and the description of the first input element. For example, if a user is located in country A based on the user profile, the user may be associated with a selectable entry “country A” in a drop down list on a web page.

Alternatively, or in addition, the stored association may include that the prior touch input corresponds to touch input by one or more other users in association with the first input element. The one or more other users may share a common attribute with a user. In some aspects, the common attribute may be determined from the user profile of each user. The common attribute may include, for example, common user location, user preferences, affinity and contact information, social activity associated with the user, and/or other similar information. For example, if one or more other users located in country A are associated with “color B” button (e.g., based on user preferences), a user located in country A may be associated with “color B” button.

At step 206, based on the accessed association, a size of an active region for at least one of the first input element or a second input element of the graphical user interface is adjusted.

A second input element of the graphical user interface may correspond to a selectable graphical element as discussed in step 204 of FIG. 2. In example aspects, several selectable graphical elements may be clustered together in a graphical user interface. The second input element may be located close to the first input element of the graphical user interface.

Each selectable graphical element in a graphical user interface, as discussed above, may correspond with an invisible area called an active region that represents a portion of the touch-sensitive screen. The active region enables the selectable graphical element to be selected by a touch input, such as a finger gesture (e.g., tapping) or stylus input. In some aspects, the active region may enclose the selectable graphical element. The active region may be defined by a set of coordinates corresponding to a portion of a display area of a touch-sensitive screen. For example, the display area may be represented as a two-dimensional space including horizontal and vertical axes (e.g., x-axis and y-axis) that intersect at a common origin point (e.g., 0.0, 0.0). In some implementations, the size of an active region corresponding to a selectable graphical element may be at least larger than and/or equal to the size of the selectable graphical element.

In some aspects, the size of a selectable graphical element may be large enough for users to perceive the selectable graphical element as touchable, such as a minimum physical size (e.g., 5 mm×5 mm). In example aspects, the size of an active region corresponding to a selectable graphical element may be large enough for users to select the selectable graphical element as touchable. For example, the size of the active region corresponding to a selectable graphical element may be larger than the size of the average human finger pad size (e.g., 10-14 mm in each dimension) and/or the average human fingertip size (e.g., 8-10 mm in each dimension). The size of a selectable graphical element may be expressed as a physical size of the selectable element, such as 15 mm×15 mm. The size of the active region corresponding to a selectable graphical element may be expressed as a physical size of the active region, such as 20 mm×20 mm.

In some implementations, the size of a selectable graphical element may be expressed as a respective width and height of pixels of the touch-sensitive screen on the user device (e.g., computing device 102-106), such as 44×44 pixels. The size of an active region corresponding to a selectable graphical element may be expressed as a respective width and height of pixels of the touch-sensitive screen on the user device (e.g., computing device 102-106), such as 58×58 pixels. In some aspects, the respective width and height of pixels may be determined by at least the screen density and the physical size of the selectable graphical element and/or the active region (e.g., mm×mm, inch×inch). Screen density may be determined as dots per inch or pixels per inch, based on the physical size of the touch-sensitive screen and display resolution (e.g., 640 pixels×480 pixels). As mentioned above with reference to step 204 of FIG. 2, the stored association may include that the prior touch input corresponds to a positive signal for the first input element. Consequently, the size of the active region for the first input element may be increased relative to the size of the active region for the second input element. For example, the size of the active region for an OK button in a graphical user interface may be increased relative to a CANCEL button if a user hit the OK button frequently in a graphical user interface (e.g., by increasing the size of the OK button and/or decreasing the size of the CANCEL button).

As noted above with reference to step 204 of FIG. 2, the stored association may include that the prior touch input corresponds to a negative signal for the first input element. Consequently, the size of the active region for the first input element may be decreased relative to the size of the active region for the second input element (e.g., by decreasing the size of first input element and/or increasing the size of the second input element). For instance, the size of the active region of a new tab button may be decreased if a user intended to select the close tab button close to the new tab button identified based on a correction behavior.

As mentioned above with reference to step 204 of FIG. 2, the stored association may include that the prior touch input corresponds to touch input by a user in association with the first input element. Consequently, the size of the active region for at least one of the first input element or a second input element of the graphical user interface may be adjusted for the user. For example, the size of the active region for a selectable entry “country A” in a drop down list on a web page may be adjusted for a user located in country A.

As noted above with reference to step 204 of FIG. 2, the stored association may include that the prior touch input corresponds to touch input by one or more other users in association with the first input element. The one or more other users may share a common attribute with a user. Consequently, the size of the active region for at least one of the first input element or a second input element of the graphical user interface may be adjusted for the user. For example, the size of the active region for a “color B” button may be adjusted for a user located in country A if one or more other users located in country A are associated with “color B” button (e.g., based on user preferences).

In some implementations, adjusting the size of the active region comprises increasing the size of the active region for one of the first input element or the second input element. For example, the size of the active region of the first input element may be increased by a predetermined amount, such as 10%. The size of the active region of the second input element may not be adjusted. Alternatively or in addition, adjusting the size of the active region comprises decreasing the size of the active region for one of the first input element or the second input element. For instance, the size of the active region of the second input element may be decreased by a predetermined amount, such as 10%. The size of the active region of the first input element may not be adjusted. In some aspects, adjusting the size of the active region comprises increasing the size of the active region for one of the first input element or the second input element, and decreasing the size of the active region for the other one of the first input element or the second input element. For example, the size of the active region of the first input element may be increased by a predetermined amount, such as 10%, and the size of the active region of the second input element may be decreased by a predetermined amount, such as 10%.

At step 208, the graphical user interface based on the adjusted size of the active region is displayed. In example aspects, after the size of the active region has been adjusted, touch input within the graphical user interface may be received, and the received touch input based on the adjusted size of the active region may be processed. For example, after the size of the active region of an OK button is increased in a graphical user interface, it may be easier for a user to select the OK button.

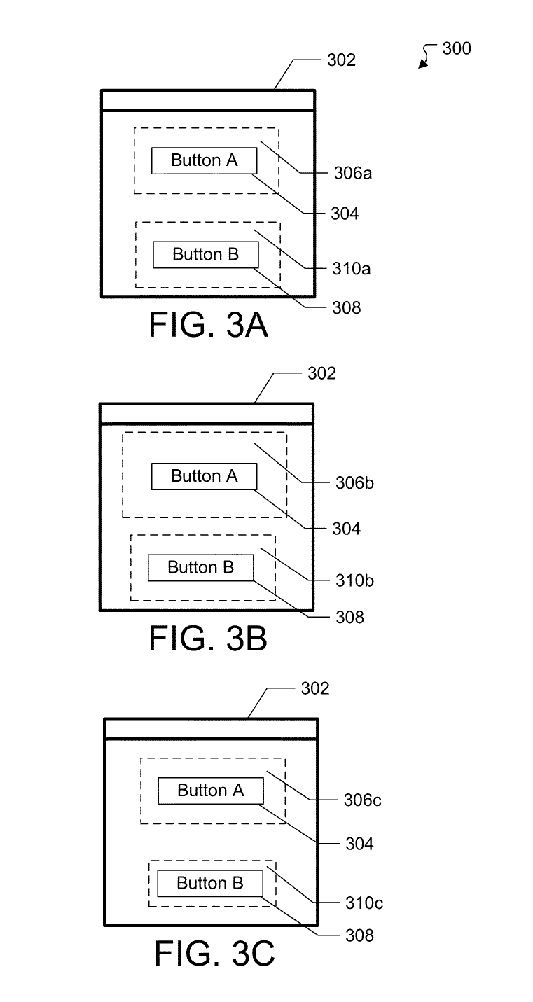

FIGS. 3A-3C illustrate example graphical user interfaces running on a computing device, where the graphical user interfaces include one or more active regions for one or more selectable graphical elements. For example, user interface 300 may be provided in an implementation of a web browser for a mobile device (e.g., computing device 102 of FIG. 1, as described above). However, user interface 300 is not limited thereto.

User interface 300 includes a graphical user interface 302, a Button A 304 and a Button B 308.

FIG. 3A illustrates an example graphical user interface running on a computing device, where the graphical user interface includes one or more original active regions for one or more selectable graphical elements.

Graphical user interface 302 includes Button A 304, Button B 308, an active region 306a for Button A 304 and an active region 310a for Button B 308. In some aspects, Button A 304 may correspond to the first input element of graphical user interface 302 as discussed above with reference to FIG. 2. Button B 308 may correspond to the second input element of graphical user interface 302 as discussed above with reference to FIG. 2. While FIGS. 3A-3C illustrate two input elements (e.g., buttons 304 and 308 with corresponding active regions 306a-c and 310a-c), the subject technology is not limited thereto, and can apply to other multiples of input elements, as well as to groupings of different input elements. Active region 306a may correspond to an original active region (e.g., without adjustment) for Button A 304. Active region 310a may correspond to an original active region (e.g., without adjustment) for Button B 308.

Active region 306a may enclose Button A 304. In some aspects, where the display area of Button A 304 is represented as an area A, the area of active region 306a may be represented by an area c×A, where c is a value greater than 1 that represents a value by which the area A is multiplied. The area A may be expressed in a number of pixels as discussed with reference to FIG. 2, such as 2500 pixels in one example. In another example, the area A may be expressed as a respective width and height of pixels, such as 50×50 pixels.

Active region 310a may enclose Button B 308. In some implementations, where the display area of Button B 308 is represented as an area D, the area of active region 310a may be represented by an area g×D, where g is a value greater than 1 that represents a value by which the area D is multiplied. The area D may be expressed in a number of pixels, such as 3600 pixels in one example. In another example, the area D may be expressed as a respective width and height of pixels, such as 60×60 pixels.

FIG. 3B illustrates an example graphical user interface running on a computing device, where the graphical user interface includes an adjusted active region for one or more selectable graphical elements.

Graphical user interface 302 includes Button A 304, Button B 308, an adjusted active region 306b for Button A 304 and active region 310b for Button B 308. Active region 310b may correspond to active region 310a of FIG. 3A. In some aspects, active region 306a may be expanded based on the stored association with Button A 304 as discussed above with reference to FIG. 2. Active region 306a may be expanded to adjusted active region 306b by a predetermined amount, such as based on a linear growth algorithm. In some aspects, active region 306a may be expanded to adjusted active region 306b in at least one dimension (e.g., width and/or height). For example, active region 306a (e.g., area of 60×60 pixels) may be expanded by 10% at the respective width and height of pixels to adjusted active region 306b (e.g., area of 66×66 pixels) if one prior touch input corresponding to Button A is received. Active region 306a (e.g., area of 60×60 pixels) may be expanded by 20% to adjusted active region 306b (e.g., area of 72×72 pixels) if two prior touch inputs corresponding to Button A are received. Active region 306a may be expanded to adjusted active region 306b without exceeding a predetermined limit. For example, the size of adjusted active region 306b may not exceed 80×80 pixels regardless of the number of touch inputs corresponding to Button A is received.

FIG. 3C illustrates an example graphical user interface running on a computing device, where the graphical user interface includes an adjusted active regions for one or more selectable graphical elements.

Graphical user interface 302 includes Button A 304, Button B 308, active region 306c for Button A 304 and an adjusted active region 310c for Button B 308. Active region 306c may correspond to active region 306a of FIG. 3 A. In some aspects, active region 310a may shrink based on the stored association with Button A 304 as discussed above with reference to FIG. 2. Active region 310a may shrink to adjusted active region 310c by a predetermined amount, such as based on an exponential back-off algorithm. In some aspects, active region 310a may shrink to adjusted active region 310c in at least one dimension (e.g., width and/or height). For example, active region 310a (e.g., area of 60×60 pixels) may shrink by half at the respective width and height of pixels to adjusted active region 310c (e.g., area of 30×30 pixels) if one prior touch input corresponding to Button A is received. Active region 310a (e.g., area of 60×60 pixels) may shrink by 3/4 to adjusted active region 310c (e.g., area of 15×15 pixels) if two prior touch inputs corresponding to Button A are received. Active region 310a may shrink to adjusted active region 310c without exceeding a predetermined limit. For example, the size of adjusted active region 310c cannot be smaller than 5×5 pixels regardless of the number of touch inputs corresponding to Button A is received.

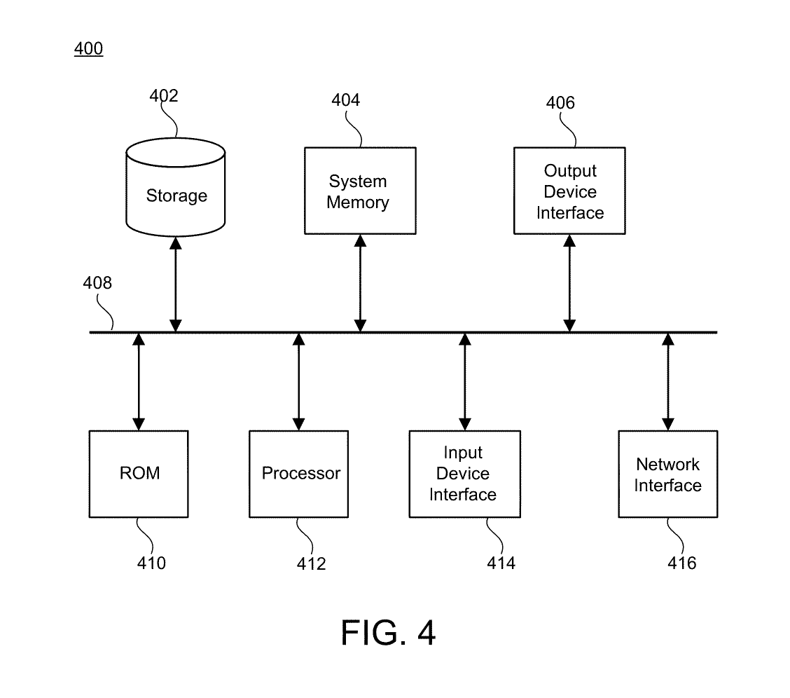

FIG. 4 conceptually illustrates an example electronic system with which some implementations of the subject technology can be implemented. Electronic system 400 can be a computer, phone, PDA, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (for example, a magnetic or optical disk and its corresponding disk drive) as permanent storage device 402.

Other implementations use a removable storage device (for example, a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, or ROM 410. For example, the various memory units include instructions for adjusting active regions within graphic user interfaces. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, for example, cathode ray tubes (CRT) or liquid crystal displays (LCD). Some implementations include devices, for example, a touchscreen that functions as both input and output devices.

Finally, as shown in FIG. 4, bus 408 also couples electronic system 400 to a network (not shown) through a network interface 416. In this manner, the computer can be a part of a network of computers (for example, a local area network (“LAN”), a wide area network (“WAN”), or an Intranet, or a network of networks, for example, the Internet. Any or all components of electronic system 400 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A system for adjusting a size of an active region within a graphical user interface, the system comprising:
one or more processors; and
a machine-readable medium comprising instructions stored therein, which when executed by the processors, cause the processors to perform operations comprising:
accessing a stored association between a first input element of a graphical user interface and prior touch input corresponding to the first input element;
adjusting, based on the accessed association, a size of an active region for at least one of the first input element or a second input element of the graphical user interface; and
displaying the graphical user interface based on the adjusted size of the active region.

2. The system of claim 1, further comprising:
receiving, prior to the accessing, the prior touch input corresponding to the first input element; and
storing the association between the first input element of the graphical user interface and the received prior touch input.

3. The system of claim 1, wherein the size of the active region is adjusted for a user, and wherein the prior touch input corresponds to touch input by the user in association with the first input element.

4. The system of claim 1, wherein the size of the active region is adjusted for a user, and wherein the prior touch input corresponds to touch input by one or more other users in association with the first input element.

5. The system of claim 4, wherein the one or more other users share a common attribute with the user.

6. The system of claim 1, wherein adjusting the size of the active region comprises:
increasing the size of the active region for one of the first input element or the second input element.

7. The system of claim 1, wherein adjusting the size of the active region comprises:
decreasing the size of the active region for one of the first input element or the second input element.

8. The system of claim 1, wherein adjusting the size of the active region comprises:
increasing the size of the active region for one of the first input element or the second input element; and
decreasing the size of the active region for the other one of the first input element or the second input element.

9. The system of claim 1, wherein the prior touch input corresponds to a positive signal for the first input element, such that the size of the active region for the first input element increases relative to the size of the active region for the second input element.

10. The system of claim 1, wherein the prior touch input corresponds to a negative signal for the first input element, such that the size of the active region for the first input element decreases relative to the size of the active region for the second input element.

11. The system of claim 1, further comprising:
receiving, after the size of the active region has been adjusted, touch input within the graphical user interface; and
processing the received touch input based on the adjusted size of the active region.

12. A machine-readable medium comprising instructions stored therein, which when executed by a system, cause the system to perform operations comprising:
accessing a stored association between a first input element of a graphical user interface and prior touch input corresponding to the first input element;
adjusting, based on the accessed association, a size of an active region for at least one of the first input element or a second input element of the graphical user interface;
receiving subsequent touch input within the graphical user interface; and
processing the received touch input based on the adjusted size of the active region.

13. The machine-readable medium of claim 12, further comprising:
receiving, prior to the accessing, the prior touch input corresponding to the first input element; and
storing the association between the first input element of the graphical user interface and the received prior touch input.

14. The machine-readable medium of claim 12, wherein the size of the active region is adjusted for a user, and wherein the prior touch input corresponds to touch input by the user in association with the first input element.

15. The machine-readable medium of claim 12, wherein the size of the active region is adjusted for a user, and wherein the prior touch input corresponds to touch input by one or more other users in association with the first input element.

16. The machine-readable medium of claim 15, wherein the one or more other users share a common attribute with the user.

17. The machine-readable medium of claim 12, wherein adjusting the size of the active region comprises:
increasing the size of the active region for one of the first input element or the second input element.

18. The machine-readable medium of claim 12, wherein adjusting the size of the active region comprises:
decreasing the size of the active region for one of the first input element or the second input element.

19. The machine-readable medium of claim 12, wherein adjusting the size of the active region comprises:
increasing the size of the active region for one of the first input element or the second input element; and
decreasing the size of the active region for the other one of the first input element or the second input element.

20. A computer-implemented method of adjusting a size of an active region within a graphical user interface, the method comprising:
accessing a stored association between a first input element of a graphical user interface and prior touch input corresponding to the first input element;
increasing or decreasing, based on the accessed association, a size of an active region for at least one of the first input element or a second input element of the graphical user interface; and
displaying the graphical user interface based on the increased or decreased size of the active region.
